(19) United States
(12) Patent Application Publication
(10) Pub. No.: US 2025/0068003 A1
(43) Pub. Date: Feb. 27, 2025

(54) LOW-LOSS PHASE SHIFTERS

(71) Applicant: Lightmatter, Inc., Boston, MA (US)

(72) Inventors: Shashank Gupta, Newton, MA (US); Jessie Rosenberg, Bedford, MA (US); Alexander Sludds, Cambridge, MA (US); Nicholas C. Harris, Menlo Park, CA (US); Darius Bunandar, Boston, MA (US)

(73) Assignee: Lightmatter, Inc., Boston, MA (US)

(21) Appl. No.: 18/809,699

(22) Filed: Aug. 20, 2024

Related U.S. Application Data
(60) Provisional application No. 63/520,917, filed on Aug. 21, 2023.

(51) Int. Cl. G02F 1/025

(52) U.S. Cl. CPC G02F 1/025; G02F 2203/50

(57) ABSTRACT

Aspects of the present application relate to an optical phase shifter including a first waveguide defined in a first semiconductor layer, the first waveguide comprising a single-mode portion, a multi-mode portion, and a tapered portion coupling the single-mode portion to the multi-mode portion. A second waveguide is defined in a second semiconductor layer, the second waveguide having a tapered portion and a tip, wherein the tapered portion of the second waveguide overlaps with the tapered portion of the first waveguide. For tuning the phase change, a first electrically resistive path, defined at least partially in the first semiconductor layer, is included. The first electrically resistive path intersects the multi-mode portion of the first waveguide.

### CROSS-REFERENCE TO RELATED APPLICATION

This application claims the benefit under 35 U.S.C. § 119 (e) of U.S. Provisional Application Ser. No. 63/520,917, filed Aug. 21, 2023, under Attorney Docket No. L0858.70081US00 and entitled “SILICON THERMAL PHASE SHIFTER BASED ON A WAVEGUIDE CROSSING,” which is hereby incorporated herein by reference in its entirety.

### BACKGROUND

Phase shifters are photonic components that may be used to introduce phase delays to light signals traveling through optical fibers or waveguides that are optically coupled with the phase shifter. Phase shifters have a modulatable refractive index. Accordingly, by modulating the refractive index, the phase delay applied to the corresponding light signals may be controlled.

### BRIEF SUMMARY

Some embodiments relate to an optical phase shifter comprising: a first waveguide defined in a first semiconductor layer, the first waveguide including a single-mode portion, a multi-mode portion, and a tapered portion coupling the single-mode portion to the multi-mode portion; a second waveguide defined in a second semiconductor layer, the second waveguide including a constant portion, a tapered portion, and a tip, wherein the tapered portion of the second waveguide overlaps with the tapered portion of the first waveguide and the tip of the second waveguide overlaps with the multi-mode portion of the first waveguide; a first electrically resistive path defined at least partially in the first semiconductor layer, wherein the first electrically resistive path intersects the multi-mode portion of the first waveguide; and first and second contacts electrically coupled to the first electrically resistive path.

In some embodiments, the tip of the second waveguide overlaps a region where the first electrically resistive path intersects the multi-mode portion of the first waveguide.

In some embodiments, the tip of the second waveguide is within 1 μm of a region where the first electrically resistive path intersects the multi-mode portion of the first waveguide.

In some embodiments, the first semiconductor layer is made of silicon and the second semiconductor layer is made of silicon nitride.

In some embodiments, the optical phase shifter further comprises a third waveguide defined in the second semiconductor layer, the third waveguide comprising a constant portion, a tapered portion, and a tip, wherein the tapered portion of the third waveguide overlaps with the tapered portion of the first waveguide and the tip of the third waveguide overlaps with the multi-mode portion of the first waveguide.

In some embodiments, the tip of the second waveguide is within 4 μm of the tip of the third waveguide.

In some embodiments, the optical phase shifter further comprises a second electrically resistive path defined at least partially in the first semiconductor layer, wherein the second electrically resistive path intersects the multi-mode portion of the first waveguide; and third and fourth contacts electrically coupled to the second electrically resistive path.

In some embodiments, where the optical phase shifter further includes the second electrically resistive path, the tip of the second waveguide overlaps a region where the second electrically resistive path intersects the multi-mode portion of the first waveguide.

In some embodiments, where the optical phase shifter further includes the second electrically resistive path, the tip of the second waveguide is within 1 μm of a region where the second electrically resistive path intersects the multi-mode portion of the first waveguide.

In some embodiments, the multi-mode portion of the first waveguide is less than 8 μm in length.

In some embodiments, the tip of the second waveguide is at least 2 μm away from the single-mode portion of the first waveguide.

Some embodiments relate to an optical phase shifter comprising: a first waveguide defined in a first semiconductor layer, the first waveguide including a single-mode portion, a multimode portion, and a tapered portion coupling the single-mode portion to the multi-mode portion; a second waveguide defined in a second semiconductor layer, the second waveguide including a constant portion, a tapered portion, and a tip, wherein the tapered portion of the second waveguide overlaps with the tapered portion of the first waveguide and the tip of the second waveguide is at least 2 μm away from the single-mode portion of the first waveguide; a first electrically resistive path defined at least partially in the first semiconductor layer, wherein the first electrically resistive path intersects the multi-mode portion of the first waveguide; and first and second contacts electrically coupled to the first electrically resistive path.

### BRIEF DESCRIPTION OF THE DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1 is a schematic diagram illustrating a phase shifter 100, in accordance with some embodiments.

FIG. 2A is a schematic diagram illustrating the phase modulating components of phase shifter 100, in accordance with some embodiments.

FIG. 2B is a schematic diagram illustrating an embodiment of a coupling region between the input waveguide and the tunable waveguide in more detail, in accordance with some embodiments.

FIG. 3 is a schematic diagram illustrating the input/output coupling components of phase shifter 100, in accordance with some embodiments.

FIG. 4 is a diagram of the optical density through a phase shifter, in accordance with some embodiments.

FIG. 5 is a schematic diagram illustrating the intersection region of phase shifter 100, in accordance with some embodiments.

FIG. 6 is a schematic diagram illustrating a side view of the intersection region of phase shifter 100, in accordance with some embodiments.

FIG. 7 is a schematic diagram illustrating the resistive path of phase shifter 100, in accordance with some embodiments.

FIG. 8 is a schematic diagram illustrating a second phase shifter, in accordance with some embodiments.

FIG. 9 is a diagram illustrating the ratio of the crossing intensity vs. the length, in accordance with some embodiments.

FIG. 10 is a diagram illustrating the optical power handling of a silicon thermal phase shifter, in accordance with some embodiments.

### DETAILED DESCRIPTION

Described herein are low-loss optical phase shifters. The optical phase shifters may be used in integrated optical circuits, optical communications, lidar, optical accelerators, and other photonic applications that utilize optical phase shifting as a way to manipulate light. For example, these optical phase shifters may be used to facilitate optical processing through optical adders in computational units such as optical accelerators.

Optical accelerators may perform a high number of computations in parallel at high speed by encoding values into light signals and executing computations in the optical domain. Light signals may be encoded with values by modulating the phase of the light by the optical phase shifter and subsequently combined or interfered in the optical domain. For optical computations, many optical phase shifters may be used in parallel to execute such computations on separate waveguides. For example, optical integrated circuits may include thousands of phase shifters operating in parallel for encoding values in optical signals. The optical phase shifters may be implemented as thermo-optic phase shifters, although other effects (e.g., electro-optic effect) can alternatively been used. Thermo-optic phase shifters operate by heating a semiconductor (usually silicon, in silicon photonics) to induce changes in the refractive index through the thermo-optic effect. The changes in the refractive index induce changes in the phase of light passing through the thermo-optic material. To control the refractive index of the thermo-optic material, resistive heaters are configured adjacent to the thermo-optic material. Accordingly, by passing current through the resistive heater, the thermo-optic material is heated, thus changing the refractive index and inducing a phase shift of light passing through the thermo-optic material.

The results of such optical processes may be read out in the electrical domain for use with conventional silicon integrated circuits (ICs). The computational power of such optical accelerators is limited by the signal-to-noise of the photonic computational components. One factor limiting the signal-to-noise ratio of optical integrated circuits is optical loss in the system. For systems exhibiting high losses, more is power consumed, thus requiring generation of more optical light to offset the losses, dramatically increasing the power needs of the system.

The inventors have recognized and appreciated that there are several effects that contribute to optical losses in photonic systems, including scattering loss due to waveguide roughness, lossy transition from one waveguide layer to another waveguide layer, absorption in doped region, scattering due to irregular geometries (e.g., angles, corners), and nonlinear absorption (NLA). The inventors have further recognized and appreciated that NLA is the dominant lossy effect in thermo-optic phase shifters. Nonlinear optical absorption in integrated photonics refers to the phenomenon where the absorption of light by a material depends nonlinearly on the intensity of the incident light. Examples on NLA include two-photon absorption, saturable absorption, and multiphoton absorption. Nonlinear absorption introduces losses and distortions in photonic circuits. NLA exhibits a threshold power, above which the nonlinear effects become significant and start to dominate the interaction between light and the material. This threshold is related to the intensity (or power density) of the incident light required to induce noticeable nonlinear absorption. As such, NLA increases with increased power density.

Recognizing this limitation, the inventors have developed a phase shifter designed to limit NLA loss. The inventors have recognized that even though reducing NLA may result in an increase of other types of loss, the increased losses are justified if NLA loss is reduced significantly (e.g., ×10 or ×100 times relative to conventional phase shifters) because NLA is the dominant mechanism.

The phase shifters developed by the inventors are designed to inject input light directly into the region that is heated by the passage of electric current (e.g., the input waveguide extends closer to the heated region). This represents a significant change relative to previous designs, where light is injected in a waveguide portion that precedes the heated region by several microns. In conventional implementations, the waveguide portion preceding the heated region is configured as a single mode waveguide to improve adiabatic coupling between the input waveguide and the heated region. Accordingly, the waveguide portion preceding the heated region is configured to minimize coupling losses. However, single-mode waveguides concentrate the optical mode within the waveguide core to a greater extent than multi-mode waveguides. The higher optical power density present in single-mode waveguides renders these waveguides more susceptible to NLA.

The present application is directed to designs that reduce the extent to which light travels in a region of high mode confinement, thereby reducing NLA losses. In some embodiments, this is accomplished by designing the input waveguide to have a tapered portion that overlaps with the tapered portion of the main waveguide and a tip that overlaps with the multi-mode portion of the main waveguide. Additionally, or alternatively, reducing the extent to which light travels in a region of high mode confinement is accomplished by designing the input waveguide to have a tip that is at least 2 μm away from the single-mode portion of the main waveguide.

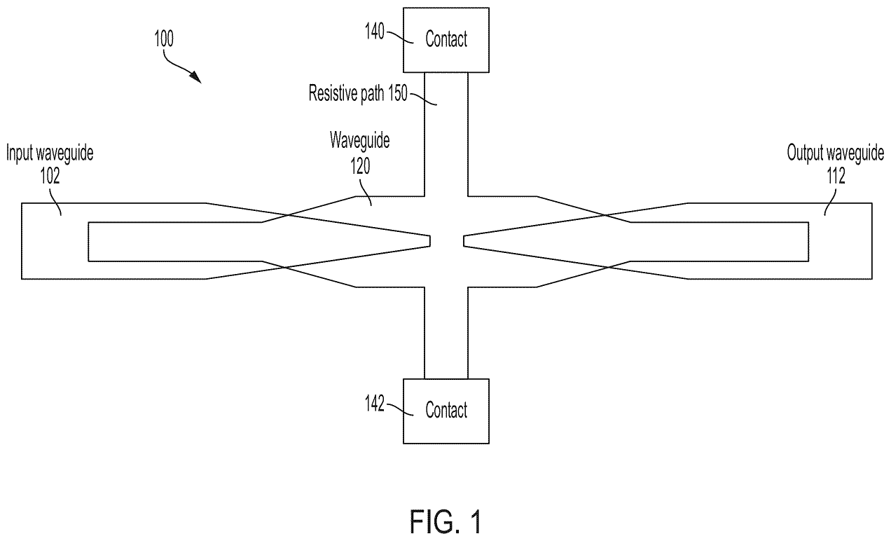

FIG. 1 is a schematic diagram illustrating a phase shifter 100, in accordance with some embodiments. Materials with large thermo-optic coefficients are ideal materials for use with phase shifters as they provide a high degree of tunability in response to applied heat. However, as discussed above, such materials are also prone to significant NLA losses. Accordingly, photonic circuits utilize materials with lower losses to carry optical signals (e.g., silicon nitride) and utilize materials with large thermo-optic coefficients at specific junctions for implementing a desired phase shift (e.g., silicon). Accordingly, some embodiments include optical couplings to transfer light from the low loss carrier waveguide to the thermo-optic material. For compact applications, optical couplings may be stacked, with one material disposed above the other, such that the optical coupling footprint is reduced. As shown in FIG. 1, phase shifter 100 includes an input waveguide 102 for coupling light into tunable waveguide 120. Tunable waveguide 120 is configured for resistive heating to tune the refractive through heating of the waveguide structure. Phase shifter 100 further includes an output waveguide 112 for coupling light out of tunable waveguide 120.

Input waveguide 102 and output waveguide 112 are disposed in the same plane (e.g., on a same layer of a substrate). The tunable waveguide 120 is disposed in a different plane (e.g., a different layer of the substrate or on a separate substrates) than the input and output waveguides. In some embodiments, the input and output waveguides are disposed in a top layer of the phase shifter and the tunable waveguide is disposed in a bottom layer of the phase shifter. In some embodiments, the input and output waveguides are disposed in a bottom layer of the phase shifter and the tunable waveguide is disposed in a top layer of the phase shifter.

The tunable waveguide 120 includes resistive path 150 for carrying current between two contacts 140 and 142. The current passing through the resistive path 150 generates heat, changing the refractive index of the tunable waveguide 120 and resulting in a tunable phase shift between the light received from input waveguide 120 and the light received by output waveguide 112 as light passes through the heated region (where the resistive path intersects the optical path).

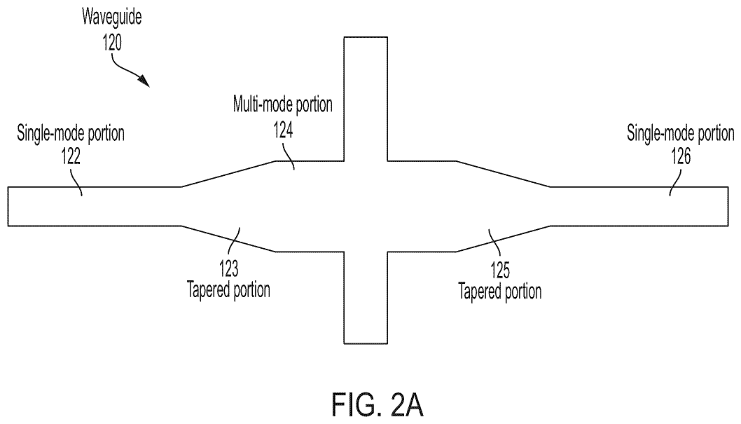

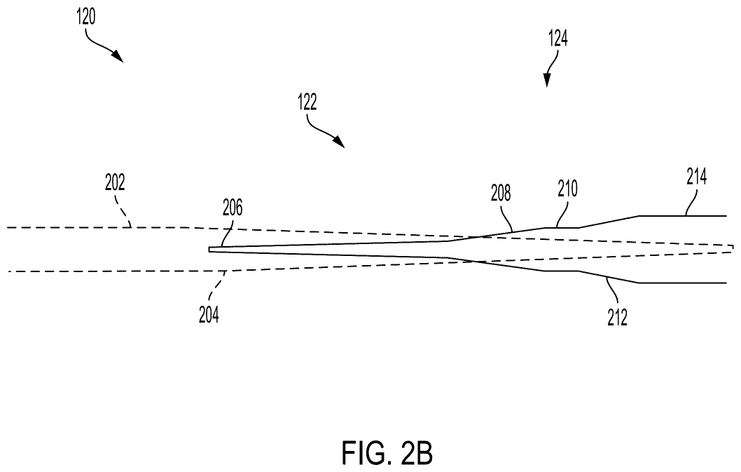

FIG. 2A is a schematic diagram illustrating tunable waveguide 120 in more detail, in accordance with some embodiments. A multi-mode portion 124 is used in the crossing region to manipulate the optical mode to have low overlap with the edges of the waveguide. In this way, other structures, such as resistive path 150, can cross the multi-mode region without causing losses due to the sudden change in the waveguide cross-section at the crossing region. Tunable waveguide 120 includes single-mode portions 122 and 126 disposed at the input end and the output end, respectively. The single-mode portions are optically coupled to a central multi-mode portion 124. Single-mode portion 122, at the input side, is coupled to central multi-mode portion 124 through tapered portion 123. Similarly, single-mode portion 126, at the output side, is coupled to central multi-mode portion 124 through tapered portion 125. The presence of the single-mode portions facilitates adiabatic coupling between waveguide 120 and the input and output waveguides. However, as described below, the extent to which light is permitted to travel in the single-mode portions is significantly reduced in order to reduce NLA. In some embodiments, multi-mode portion 124 may be less than 8 μm in length, less than 7 μm in length, less than 6 μm in length, less than 5 μm in length or less than less than 4 μm in length. Designing the multi-mode portion to be relatively short further reduces loss due to NLA.

In some embodiments, the single-mode portions 122 and 126 are straight. In other embodiments, the single-mode portions 122 and 126 are tapered in the reverse directions of the input and output coupling waveguides. For example, the single-mode potion 122 may have a point terminating at the start of the tapered region of the input coupling waveguide, where the start and end are from the perspective of a propagating optical mode (e.g., starting on the left and ending on the right). The single-mode portion may then expand through a tapered region from the terminating point until the slope of the taper increases at tapered portion 123. Accordingly, the single-mode region may be a gradual-taper region 122 and the tapered region 123 may be a steep-tapered region. Similarly, the single mode portion 126 may have a termination point at the end of the tapered region of the output waveguide. The single mode portion 126 may be a gradual-taper region and the tapered region 125 may be a steep-tapered region. In some embodiments the tunable waveguide has a straight (e.g., non-tapered) region between the two steep-tapered regions 123 and 125.

FIG. 2B is a schematic diagram illustrating an embodiment of a coupling region between the input waveguide 102 and the tunable waveguide 120 in more detail, in accordance with some embodiments. The single-mode portion 122 is tapered and the multi-mode portion includes multiple tapered regions having different slopes. The single-mode portion 122 of waveguide 120 includes tapered region 206. The termination tip of tapered region 206 is aligned with the start of tapered region 204 of the input waveguide 202. Following gradual tapered region 206, the waveguide 120 widens into the multi-mode portion 124. The multi-mode portion 124 of the waveguide 120 includes a steeper tapered region 208 which becomes more gradual in region 210. Following region 210, multi-modal portion of the waveguide includes a steeper region 212 included before parallel region 214.

In some embodiments, region 210 may be a parallel region of the multimodal waveguide. In some embodiments, region 210 may have a tapered slope smaller than that of region 208 and 212.

Tunable waveguide 120 may be defined by any suitable semiconductor layer that has a thermo-optic coefficient sufficient for modulating the phase of optical signals. In some embodiments, tunable waveguide 120 is defined in a silicon layer. In some embodiments, additional materials that are less susceptible to NLA, such as silicon nitride and/or silicon dioxide, may be incorporated around the device to decrease NLA.

In some embodiments, the tunable waveguide itself may be defined by silicon nitride, or silicon dioxide, or other dielectric waveguide material.

In some embodiments, the phase shifter may be used in material platforms with metals that would otherwise be deleterious to the optical mode profile, such as lithium niobate, barium titanate, silicon carbide, aluminum nitride, gallium arsenide, and others. In these platforms, additional dielectric materials may be deposited on top of the crossing to engineer the RF mode and DC electric field. Accordingly, the additional dielectric materials may improve the phase shifting efficiency of the phase shifter.

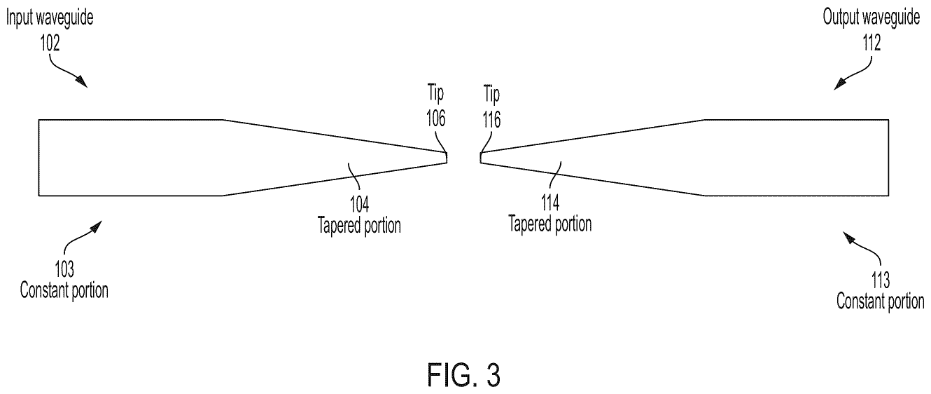

FIG. 3 is a schematic diagram illustrating the input/output coupling components of phase shifter 100, in accordance with some embodiments. Input waveguide 102 includes constant portion 103 (having substantially straight and parallel sidewalls) which transitions to a tapered portion 104 terminating in tip 106. Output waveguide 112 includes constant portion 113 which similarly transitions to a tapered portion 114 terminating in tip 116. The size of the tips may be dictated by the minimum feature resolution associated with the photolithography.

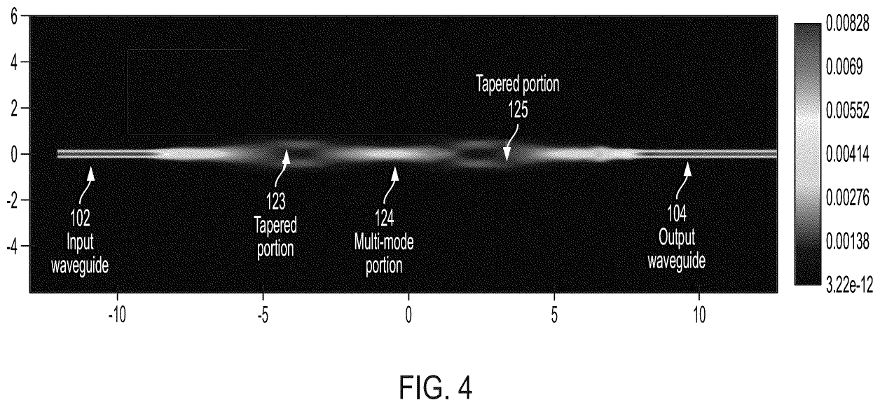

FIG. 4 is a diagram of the optical power density through phase shifter 100, in accordance with some embodiments. The optical power profile is generated by 3D finite different time domain simulations (FDTD) in a cross-section of the device through the middle of the waveguide. As can be appreciated from FIG. 4, the optical power density within the tapered portions 123 and 125 is substantially lower than in the input and output waveguides, thereby reducing NLA. To increase the thermo-optic effect while reducing NLA, higher power density is concentrated in a relatively small region (e.g., less than 3 μm in length), where the waveguide intersects the resistive path.

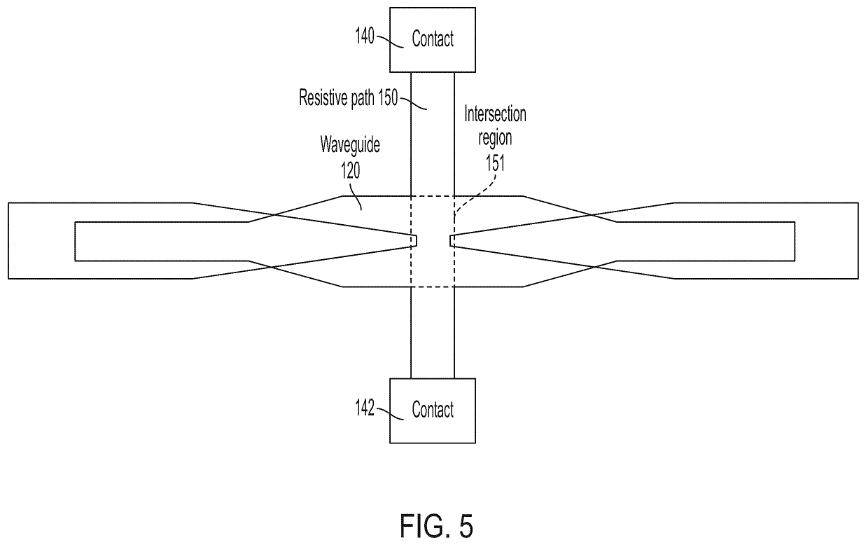

FIG. 5 is a schematic diagram illustrating the intersection region of phase shifter 100, in accordance with some embodiments. The region where resistive path 150 intersects waveguide 120 is defined as intersection region 151. The phase shifter is designed to reduce NLA by including waveguides that are configured to couple light from the input waveguide directly into the multi-mode waveguide, reducing coupling to the single mode portions of the tunable waveguide. As shown in FIG. 5, the tapered portion 104 of the input waveguide overlaps with the tapered portion 123 of the tunable waveguide. Similarly, the tapered portion 114 of the output waveguide overlaps with the tapered portion 125 of the tunable waveguide.

Although the example illustrated in FIG. 5 illustrates straight waveguides used in the single-mode region of the tunable waveguide, the single-mode regions may include gradual tapers as described above. The gradual tapers may include termination points aligned with the beginning of the tapered region of the input waveguide and ending with the end of the tapered region of the output waveguide. Accordingly, the length of the single mode portions of the tunable waveguide may be shorter (and more tapered) than shown in FIG. 5.

In some embodiments, the tip of the input waveguide overlaps (e.g., such that the input waveguide crosses into) a region where the first electrically resistive path 150 intersects the multi-mode portion of the tunable waveguide 120, thereby minimizing the presence of light in the single-mode portions of tunable waveguide 120. Alternatively, the tips may be outside the intersection region 151, but only by a small distance (e.g., within 1 μm or within 3 μm of the intersection region). To ensure that propagation in the single-mode portions of the tunable waveguide is limited, in some embodiments, the tip 106 may be at least 2 μm away (or at least 4 μm away) from the single-mode portion 122. Similarly, the tip 116 may be at least 2 μm away (or at least 4 μm away) from the single-mode portion 126.

In some embodiments, the tip 106 of the input waveguide is within 10 μm of the tip 116 of the output waveguide, within 8 μm of the tip 116 of the output waveguide, within 6 μm of the tip 116 of the output waveguide, within 4 μm of the tip 116 of the output waveguide, or within 2 μm of the tip of the output waveguide.

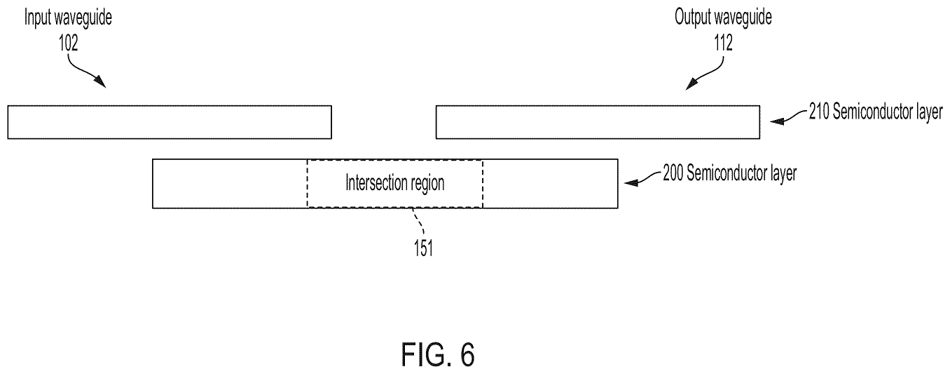

FIG. 6 is a schematic diagram illustrating a side view of the intersection region of phase shifter 100, in accordance with some embodiments. The tunable waveguide 120 is disposed in semiconductor layer 200 and is configured as a bottom layer of the phase shifter. Input waveguide 102 and output waveguide 112 are disposed in semiconductor layer 210 and is configured as a top layer of the phase shifter. The coupling ends of the input waveguide 102 and output waveguide 112 are configured above the intersection region 151. In some embodiments, semiconductor layer 210 is made of silicon nitride or silicon oxide. In some embodiments, semiconductor layer 200 is made of silicon.

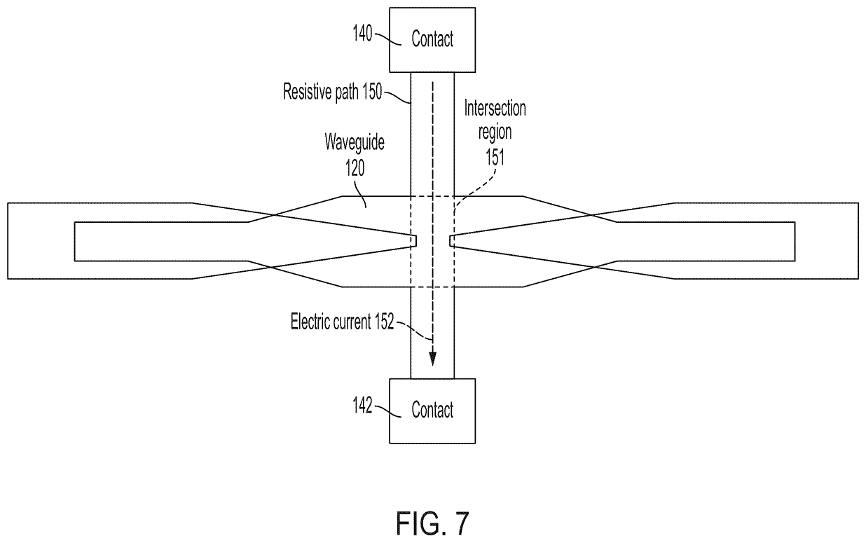

FIG. 7 is a schematic diagram illustrating an electric current 152 passing through the resistive path of phase shifter 100 in response to an applied voltage, in accordance with some embodiments. The current 152 travels from a current injection contact 140 to a current receiving contact 142. As shown in FIG. 7, the resistive path is shown as a straight linear path in a plane. However, the resistive path may be configured in any suitable geometry that allows the current 152 to pass through the intersection region 151 of the multi-mode potion of the tunable waveguide 120.

The inventors have further recognized and appreciate that for some applications the resistance of the heater may be too high to implement using a single heater. Accordingly, the inventors have developed split heater designs with multiple resistive crossing regions to reduce the resistance of the individual heaters required to achieve a desired heating.

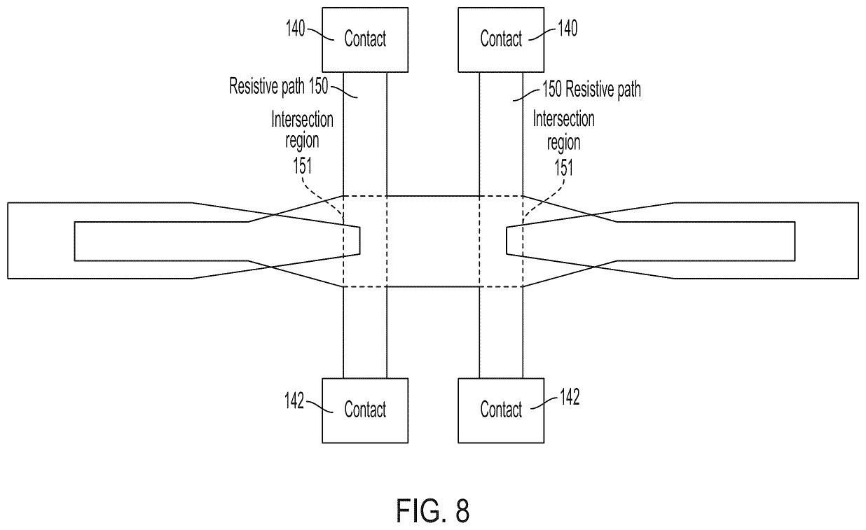

FIG. 8 is a schematic diagram illustrating a second phase shifter, in accordance with some embodiments. The tunable waveguide shown in FIG. 8 includes two intersection regions 151 with respective resistive paths 150, current injection contacts 140, and current receiving contacts 142. A first intersection region is configured in alignment with the input waveguide and a second intersection region is configured in alignment with the output waveguide. The waveguide tips may overlap the intersection regions or may be slightly outside the intersection regions (e.g., within 1 μm or within 3 μm). In some embodiments, additional resistive paths may be included.

The resistive paths may be spaced by any suitable amount to provide operable heat generation to tune the refractive index of the waveguide. In some embodiments, the center-to-center spacing between a first resistive path and a second resistive path, each crossing the tunable waveguide, is between 2 μm and 10 μm. In some embodiments, the center-to-center spacing between a first resistive path and a second resistive path is between 2 μm and 6 μm. For example, the center-to-center spacing between the first resistive path and the second resistive path may be approximately between 3 μm and 4 μm.

The resistive paths may have any suitable thickness to provide operable resistance. The thickness being the length in a plane parallel to the substrate and along a direction perpendicular to the current path. In some embodiments, the resistive paths may have a thickness between 0.2 μm and 5 μm. In some embodiments, the resistive paths may have a thickness between 0.5 μm and 4 μm. In some embodiments, the resistive paths may have a thickness between 0.5 μm and 2 μm. Additionally, the resistive paths may have variable thicknesses. For example, the resistive paths may have a thickness of approximately 2 μm near the contacts and thicknesses of approximately 0.5 μm near the crossing with the tunable waveguide.

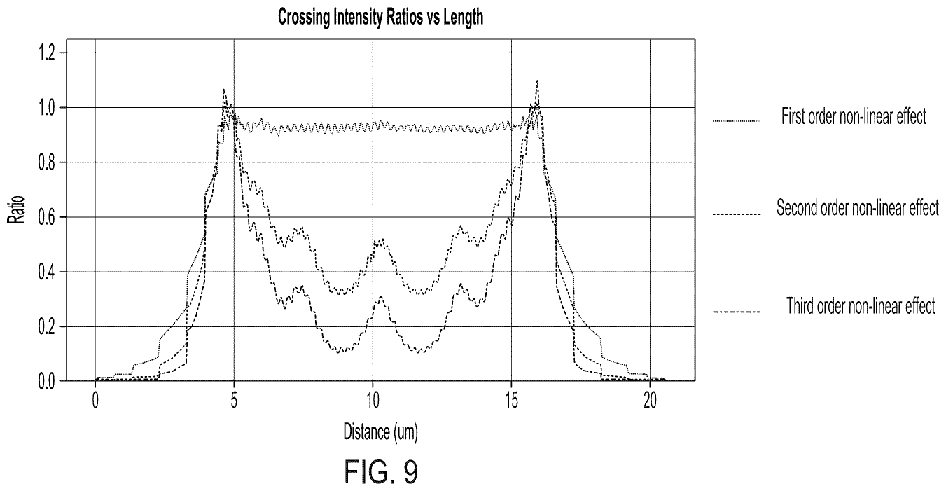

FIG. 9 is a diagram illustrating the ratio of the crossing intensity vs. the length associated with designs of the types described above. As shown in FIG. 9, the second and third order nonlinear effects decrease along the length in the crossing relative to the first order effect, leading to a substantial loss reduction relative to conventional designs. The plot is generated using 3D FDTD simulation of the crossing with field and power monitors placed approximately every 100 nm along the direction of propagation of the light. Each of the monitors is compared to the area integrals of intensity, intensity-squared, and intensity-cubed to the same area integral in a 440 nm wide single mode silicon waveguide. The ratio represents a reduction in the strength of the NLA effect and can decrease the effect of free-carrier absorption in specific sections to the crossing by up to 10-fold compared to waveguides that couple into the single mode waveguide.

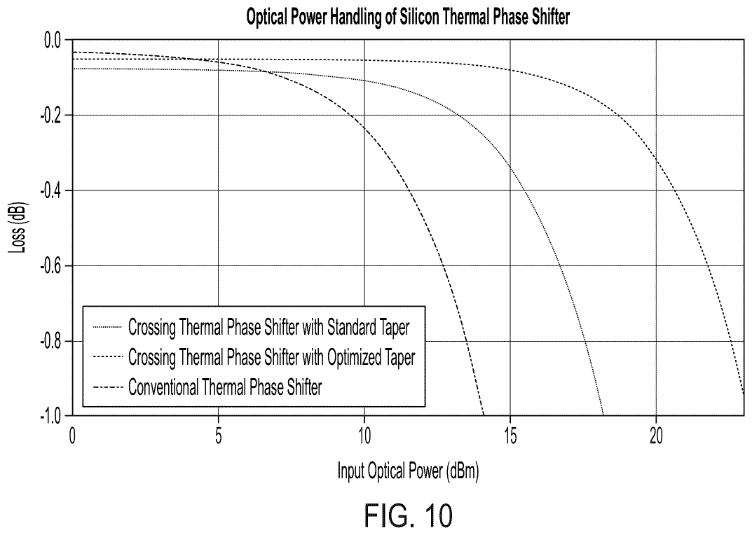

FIG. 10 is a diagram illustrating the optical power handling of a silicon thermal phase shifter, in accordance with some embodiments. Optical power handling among a conventional phase shifter (labeled “conventional phase shifter”), a phase shifter with an input waveguide that couples lights into to the single mode portion of the tunable waveguide (labeled “cross thermal phase shifter with standard taper”) and a phase shifter with a design of the types described above (labeled “cross thermal phase shifter with optimized taper”) are compared. At low optical power, the waveguide that couples to the single mode waveguide has lower optical loss than the phase shifters of the types described herein. This is because, at low optical power, sidewall roughness and coupling loss are the dominant factors. However, as the optical power into each device increases, losses from NLA (two-photon absorption at intermediate power levels and free-carrier absorption at higher power levels) increase and eventually dominate the intrinsic loss of the device. As such, phase shifters of the types described herein exhibit lower loss.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. An optical phase shifter comprising:
a first waveguide defined in a first semiconductor layer, the first waveguide comprising a single-mode portion, a multi-mode portion, and a tapered portion coupling the single-mode portion to the multi-mode portion;
a second waveguide defined in a second semiconductor layer, the second waveguide comprising a constant portion, a tapered portion and a tip, wherein the tapered portion of the second waveguide overlaps with the tapered portion of the first waveguide and the tip of the second waveguide overlaps with the multi-mode portion of the first waveguide;
a first electrically resistive path defined at least partially in the first semiconductor layer, wherein the first electrically resistive path intersects the multi-mode portion of the first waveguide; and
first and second contacts electrically coupled to the first electrically resistive path.

2. The optical phase shifter of claim 1, wherein the tip of the second waveguide overlaps a region where the first electrically resistive path intersects the multi-mode portion of the first waveguide.

3. The optical phase shifter of claim 1, wherein the tip of the second waveguide is within 1 μm of a region where the first electrically resistive path intersects the multi-mode portion of the first waveguide.

4. The optical phase shifter of claim 1, wherein the first semiconductor layer is made of silicon and the second semiconductor layer is made of silicon nitride.

5. The optical phase shifter of claim 1, further comprising:
a third waveguide defined in the second semiconductor layer, the third waveguide comprising a constant portion, a tapered portion and a tip, wherein the tapered portion of the third waveguide overlaps with the tapered portion of the first waveguide and the tip of the third waveguide overlaps with the multi-mode portion of the first waveguide.

6. The optical phase shifter of claim 5, wherein the tip of the second waveguide is within 4 μm of the tip of the third waveguide.

7. The optical phase shifter of claim 1, further comprising:
a second electrically resistive path defined at least partially in the first semiconductor layer, wherein the second electrically resistive path intersects the multi-mode portion of the first waveguide; and
third and fourth contacts electrically coupled to the second electrically resistive path.

8. The optical phase shifter of claim 7, wherein the tip of the second waveguide overlaps a region where the second electrically resistive path intersects the multi-mode portion of the first waveguide.

9. The optical phase shifter of claim 7, wherein the tip of the second waveguide is within 1 μm of a region where the second electrically resistive path intersects the multi-mode portion of the first waveguide.

10. The optical phase shifter of claim 1, wherein the multi-mode portion of the first waveguide is less than 8 μm in length.

11. The optical phase shifter of claim 1, wherein the tip of the second waveguide is at least 2 μm away from the single-mode portion of the first waveguide.

12. An optical phase shifter comprising:
a first waveguide defined in a first semiconductor layer, the first waveguide comprising a single-mode portion, a multi-mode portion, and a tapered portion coupling the single-mode portion to the multi-mode portion;
a second waveguide defined in a second semiconductor layer, the second waveguide comprising a constant portion, a tapered portion and a tip, wherein the tapered portion of the second waveguide overlaps with the tapered portion of the first waveguide and the tip of the second waveguide is at least 2 μm away from the single-mode portion of the first waveguide;
a first electrically resistive path defined at least partially in the first semiconductor layer, wherein the first electrically resistive path intersects the multi-mode portion of the first waveguide; and
first and second contacts electrically coupled to the first electrically resistive path.

13. The optical phase shifter of claim 12, wherein the tip of the second waveguide overlaps a region where the first electrically resistive path intersects the multi-mode portion of the first waveguide.

14. The optical phase shifter of claim 12, wherein the tip of the second waveguide is within 1 μm of a region where the first electrically resistive path intersects the multi-mode portion of the first waveguide.

15. The optical phase shifter of claim 12, wherein the first semiconductor layer is made of silicon and the second semiconductor layer is made of silicon nitride.

16. The optical phase shifter of claim 12, further comprising:
a third waveguide defined in the second semiconductor layer, the third waveguide comprising a constant portion, a tapered portion and a tip, wherein the tapered portion of the third waveguide overlaps with the tapered portion of the first waveguide and the tip of the third waveguide overlaps with the multi-mode portion of the first waveguide.

17. The optical phase shifter of claim 16, wherein the tip of the second waveguide is within 4 μm of the tip of the third waveguide.

18. The optical phase shifter of claim 12, further comprising:
a second electrically resistive path defined at least partially in the first semiconductor layer, wherein the second electrically resistive path intersects the multi-mode portion of the first waveguide; and
third and fourth contacts electrically coupled to the second electrically resistive path.

19. The optical phase shifter of claim 18, wherein the tip of the second waveguide overlaps a region where the second electrically resistive path intersects the multi-mode portion of the first waveguide.

20. The optical phase shifter of claim 18, wherein the tip of the second waveguide is within 1 μm of a region where the second electrically resistive path intersects the multi-mode portion of the first waveguide.
